(19) United States
(12) Patent Application Publication
(10) Pub. No.: US 2018/0005419 A1
(43) Pub. Date: Jan. 4, 2018

(54) VISUALLY INTERACTIVE AND ITERATIVE ANALYSIS OF DATA PATTERNS BY A USER

(71) Applicant: HEWLETT-PACKARD DEVELOPMENT COMPANY, L.P., HOUSTON, TX (US)

(72) Inventors: MING C HAO, PALO ALTO, CA (US); MICHAEL HUND, KONSTANZ (DE); NELSON L CHANG, PALO ALTO, CA (US); HALLDOR JANETZKO, KONSTANZ (DE); SABASTIAN MITTELSTAEDT, KONSTANZ (DE); KEVIN SMATHERS, PALO ALTO, CA (US); DANIEL KEIM, KONSTANZ (DE); DORON SHAKED, HAIFA (IL); JISHANG WEI, PALO ALTO, CA (US)

(21) Appl. No.: 15/539,788

(22) PCT Filed: Jan. 26, 2015
(86) PCT No.: PCT/US15/12924

§ 371 Date: Jun. 26, 2017

(51) Int. Cl. G06T 11/20; G06F 3/0484; G06T 5/00

(52) U.S. Cl. CPC G06T 11/206; G06T 5/002; G06F 3/04845; G06F 3/04842; G06T 2200/24

(57) ABSTRACT

Visually interactive and iterative analysis of data patterns by a user is disclosed. One example is a system including a display module and an interaction processor. The display module displays, via an interactive graphical user interface, a visual representation of a plurality of data elements and respective data relations between the data elements, and wherein each data element is represented by pixel attributes of a pixel. The interaction processor iteratively and interactively processes analysis by a user based on identifying selection, by the user, of an arbitrarily shaped region of the visual representation, clipping the selected region by zooming in to the selected region, identifying, in the clipped region, selection of data elements of interest to the user, and prompting the display module to automatically blur visual representations of data elements different from the data elements of interest by modifying the pixel attributes of respective pixels.

### BACKGROUND

Big data applications often rely on a search for patterns in the data. Such patterns may be detected, for example, based on a visualization of the data.

### BRIEF DESCRIPTION OF THE DRAWINGS

FIG. 1 is a functional block diagram illustrating one example of a system for visually interactive and iterative analysis of data patterns by a user.

FIG. 2 is an example of a visual representation of a plurality of data elements and respective data relations between data elements.

FIG. 3 illustrates an example of a characteristic of a data element represented by a pixel in the graph of FIG. 2.

FIG. 4 illustrates an example algorithm for selection and modification of a visual representation of data.

FIG. 5 illustrates an example of a selection of an arbitrarily shaped region of a visual representation of data.

FIG. 6 illustrates an example of providing a modified visual representation of the selected region of FIG. 5.

FIG. 7 illustrates an example of removal of a diagonal line from the selected region of FIG. 6.

FIGS. 8A-8C illustrate example algorithms for blurring a visual representation.

FIG. 9 illustrates an example of blurring visual representations of data elements different from the data elements of interest.

FIG. 10 illustrates another example of blurring visual representations of data elements different from the data elements of interest.

FIG. 11 is a block diagram illustrating one example of a processing system for implementing the system for visually interactive and iterative analysis of data patterns by a user.

FIG. 12 is a block diagram illustrating one example of a computer readable medium for visually interactive and iterative analysis of data patterns by a user.

FIG. 13 is a flow diagram illustrating one example of a method for visually interactive and iterative analysis of data patterns by a user.

### DETAILED DESCRIPTION

Identifying data patterns is an important task for many big data applications, such as, for example, in an investigation and analysis of security threats. Various visual techniques may be utilized to facilitate discovery of patterns. Some visual techniques may include an interactive visual representation of the data.

Generally, existing methods may aid analysis of the data by providing means to select portions of the visual representation for further analysis. However, visual representations of data are not at the pixel-level. For example, a pixel in the visual representation may not be representative of a data element. Accordingly, the selection of a portion of the visual representation may not be based on an actual data element.

Also, for example, existing methods for selection and/or extracting the portion of the visual representation may only allow for selection of regular shaped regions, such as rectangles. However, interesting data patterns may appear with arbitrary shapes in the visual representation.

Some interactive techniques may aid analysis of the data by providing means to highlight or delete portions of the visual representation for further analysis. However, such highlighting and/or deletion may generally result in a loss of useful information in the form of the underlying relations between data elements.

The interactive approach described herein is based on a two-phase processing to allow users to analyze data patterns. For example, network hunters may visually detect threats and identify actionable insights. The two-phase processing may generally include clipping interesting patterns from a big graph for detailed analysis. There is often a need to remove an interesting pattern from a visual representation. Existing methods include rectangle rubber-banding. However, many interesting patterns are arbitrarily shaped. Separate such interesting patterns from a complex visual representation, and zooming in to provide a modified visual representation are two important issues. For example, clipping interesting patterns may include cutting and zooming into, and/or extracting an arbitrary region with a diagonal line in a graph for further analysis of the behavior of a port scan. For example, in data related to security, clipping may be utilized to zoom into a region of the visual representation where the data pattern is indicative of suspicious threats, and conduct further analysis at an individual security record level (e.g., for an IP address).

Also, as described herein, certain portions of the visual representation may be highlighted to aid in an analysis of data patterns of interest to a user. For example, blurring of portions of the visual representation may be utilized to preserve respective data relations between the data elements. Accordingly, useful information in the form of the underlying relations between data elements may not be lost, while data elements of interest may be highlighted. In big data visualization, coloring plays an important role. However, there is generally no sufficient indication to identify portions of the data that may be ignored, and portions of the data that may be relevant to a user. Using a blurring technique, non-interesting data points may be blurred. For example, coloring may be utilized to apply blurring colors to assist users to ignore burred data points, and focus on important data points in a big data graph.

Also, in some examples, each pixel of a visual representation may represent a data element. In some examples, each pixel may be associated with a pixel attribute to represent an attribute of a data element. Accordingly, a user may be provided access to data record level information. Generally, visualizations for big data are not interactive. Users are unable to interact with the data at the record level. For example, a user may not have access to messages related to a specific IP address to work at a record level analysis. Further, users may not be able to process data iteratively to identify root-cause. As described herein, the visual analytics workflow may be iterative for users to validate and refine their hypotheses. Also, as described herein, interactive visual analytics may be utilized to gain situational awareness of big data and visualize the security threats.

As described in various examples herein, a visually interactive and iterative analysis of data patterns by a user is disclosed. One example is a system including a display module and an interaction processor. The display module displays, via an interactive graphical user interface, a visual representation of a plurality of data elements and respective data relations between the data elements, and wherein each data element is represented by pixel attributes of a pixel. The interaction processor iteratively and interactively processes analysis by a user based on identifying selection, by the user, of an arbitrarily shaped region of the visual representation, clipping the selected region by zooming in to the selected region, identifying, in the clipped region, selection of data elements of interest to the user, and prompting the display module to automatically blur visual representations of data elements different from the data elements of interest by modifying the pixel attributes of respective pixels.

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

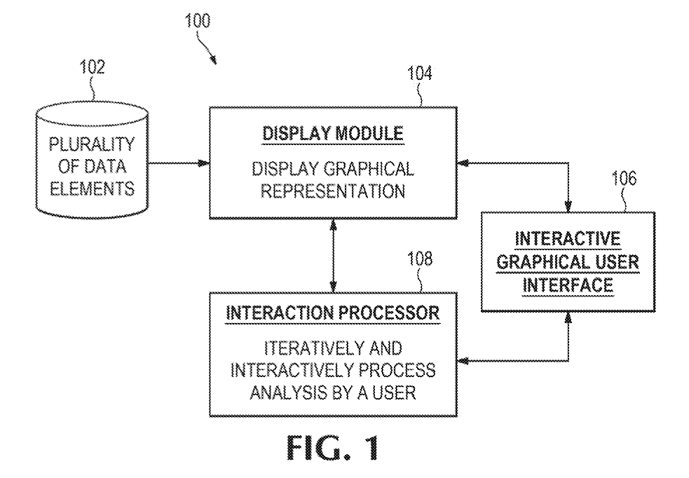

FIG. 1 is a functional block diagram illustrating one example of a system 100 for visually interactive and iterative analysis of data patterns by a user. System 100 is shown to include a display module 104 communicatively linked to an interaction processor 108. The display module 104 may receive a plurality of data elements 102. The display module 104 and the interaction processor 108 are shown to be communicatively linked to an interactive graphical user interface 108.

The term “system” may be used to refer to a single computing device or multiple computing devices that communicate with each other (e.g. via a network) and operate together to provide a unified service. In some examples, the components of system 100 may communicate with one another over a network. As described herein, the network may be any wired or wireless network, and may include any number of hubs, routers, switches, cell towers, and so forth. Such a network may be, for example, part of a cellular network, part of the internet, part of an intranet, and/or any other type of network.

The system 100 displays, via an interactive graphical user interface, a visual representation of a plurality of data elements and respective data relations between the data elements, and wherein each data element is represented by pixel attributes of a pixel. The system 100 iteratively and interactively processes analysis by a domain expert based on identifying selection, by the user, of an arbitrarily shaped region of the visual representation, clipping the selected region by zooming in to the selected region, identifying, in the clipped region, selection of data elements of interest to the user, and prompting the display module to automatically blur visual representations of data elements different from the data elements of interest by modifying the pixel attributes of respective pixels.

System 100 includes a display module 104 to display, via an interactive graphical user interface 106, a visual representation of a plurality of data elements 102 and respective data relations between data elements, and where each data element is represented by pixel attributes of a pixel. Generally, the plurality of data elements 102 describes contents of a high-dimensional dataset. In some examples, the plurality of data elements 102 may be a cyber-security log file, proxy data, Web navigation logs (e.g. click stream), and healthcare data. In some examples, the plurality of data elements 102 may be representative of a data related to a disease, the data covering a 12-hour period, and including a terabyte of data elements.

In some examples, the visual representation may include a representation of each data element by a pixel. For example, the terabyte of data elements from the disease database may be represented graphically, where each pixel in the graph represents a data element. Also, for example, the plurality of data elements 102 may represent IP addresses that are logged into a secured network during a time interval, and the visual representation may be a graphical representation of the IP addresses, where each data pixel represents a record of an IP address.

In some examples, a pixel attribute associated with the pixel may represent a characteristic of the data element represented by the pixel. For example, the pixel attribute may be color, and a color scheme may be associated with a data element. In some examples, a color may be associated with an IP address, and each pixel representing the IP address may be associated with the respective color. In some examples, each pixel may represent a range of IP addresses and a color may be associated with the range.

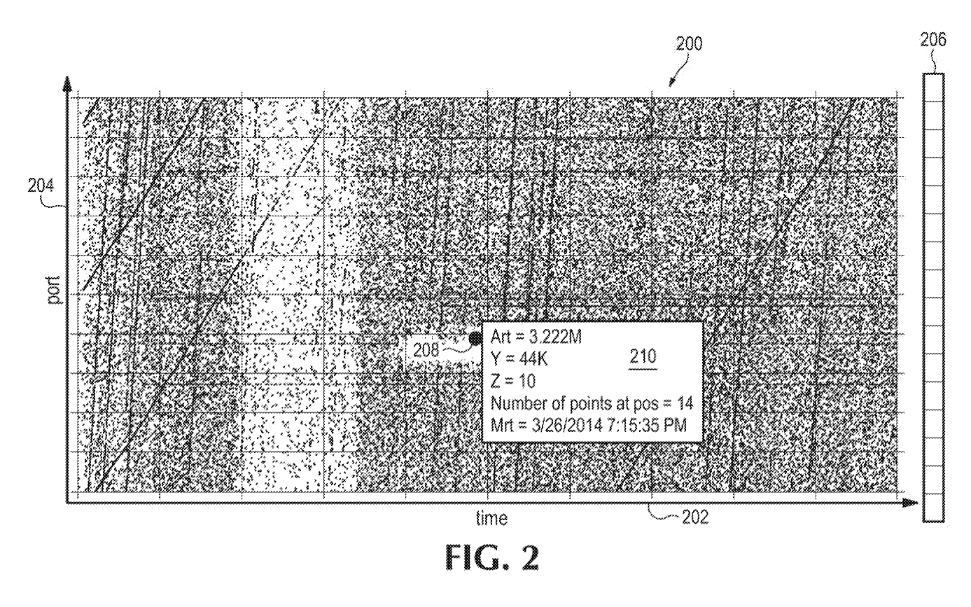

FIG. 2 is an example of a visual representation 200 of a plurality of data elements and respective data relations between data elements. For example, a high volume complex big port graph is illustrated. As illustrated, in some examples, a given data element of the plurality of data elements may be a pair comprising an IP address and a port number at a time interval. The horizontal axis may represent time 202, the vertical axis may represent port 204, and the color of a pixel 208 may represent the numerical value of an IP address. Color may represent the value of an IP address. For example, a color spectrum 206 may represent a plurality of values of IP addresses.

As described herein, the visual representation may be interactive. For example, portions of the representation may be selected to display additional features of the data elements. For example, clicking on pixel 208 may cause a pop-up 210 to be displayed. In some examples, the pop-up may be overlaid on the visual representation. Also, for example, portions of the representation may be selected for zooming in, zooming out, highlighting, deleting, and so forth. Such a visual representation of data may allow for identification of patterns in big data.

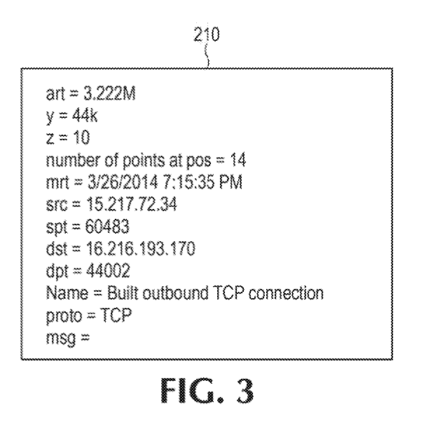

FIG. 3 illustrates an example of a characteristic of a data element represented by a pixel in the graph of FIG. 2. In particular, FIG. 3 is an illustration of pop-up 210 from FIG. 2. Several characteristics of a data element may be provided, including “art=3.222M”, “y=44K”, “z=10”, “number of points at pos=14”, “mrt=3/26/2014 7:15:35 PM”, and so forth.

Referring to FIG. 1, an interaction processor 108, may be communicatively linked to the display module 104 and an interactive graphical user interface 106, to iteratively and interactively process analysis by a user. A domain may be an environment associated with the plurality of data objects, and the user may be an entity in possession of semantic and/or contextual knowledge relevant to aspects of the domain. For example, the plurality of data objects may be related to customer transactions, and the domain may be a physical store where the customer transactions take place, and the user may have knowledge related to items purchased at the physical store and the customer shopping behavior. As another example, the plurality of data objects may be representative of Web navigation logs (e.g. click stream), and the domain may be the domain name servers that are visited via the navigation logs, and the user may have knowledge related to analysis of internet traffic. Also, for example, the plurality of data objects may be related to operational or security logs, and the domain may be a secure office space for which the security logs are being maintained and/or managed, and the user may have knowledge related to tracking security logs based on preferences such as location, time, frequency, error logs, warnings, and so forth.

Generally, the user may be an individual in possession of domain knowledge. For example, the domain may be a retail store, and the user may be the store manager. Also, for example, the domain may be a hospital, and the user may be a member of the hospital management staff. As another example, the domain may be a casino, and the user may be the casino manager. Also, for example, the domain may be a secure office space, and the user may be a member of the security staff.

As described herein, the visual representation may be interactive and iterative. Interactive processing may be performed via the interactive graphical user interface 106 by providing the visual representation to the user, identifying selection of an arbitrarily shaped region of the visual representation by the user, and providing a modified visual representation to the user. The iterative processing may include identifying another selection, by the user, of an arbitrarily shaped region of the visual representation. For example, existing methods generally rubber-band an area. Such regions may be regular shaped patterns, such as a rectangle. However, interesting patterns may appear in an arbitrarily shaped region. As described herein, system 100 facilitates selection of an arbitrarily shaped region. The user may select, modify, and/or deselect the arbitrarily shaped region, and the interaction processor 108 in communication with the display module 104, may iteratively process such selection, modification, and/or deselection to generate a modified visual representation to be provided to the user via the interactive graphical user interface 106.

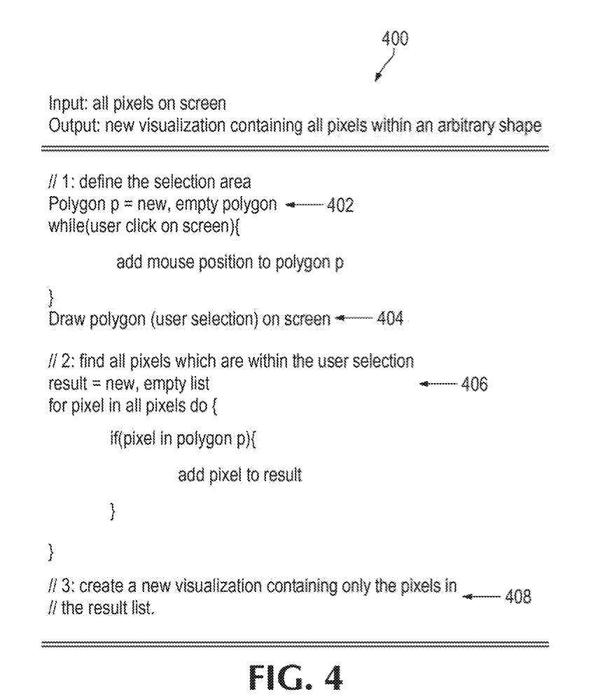

FIG. 4 illustrates an example algorithm for selection and modification of a visual representation of data. An example pseudo-code 400 for selecting an arbitrary shape is illustrated. In some examples, the interaction processor 108 may detect selection of an arbitrarily shaped region of a visual representation. For example, at 402, pixel coordinates may be identified on an interactive graphical user interface 106 based on clicked mouse positions. For example, a user may select an arbitrary region by clicking and dragging a mouse over a portion of the visual representation. At 404, in some examples, the display module 104 may display identified coordinates by a drawing a contour. At 406, in some examples, the interaction processor 108 may identify pixel coordinates in the interior of the contour, and may thereby identify the selected arbitrarily shaped region. At 408, in some implementations, the interaction processor 108 may prompt the display module 104 to providing a modified visual representation of the selected region.

In some examples, the interaction processor 106 may provide the modified visual representation of the sub-plurality of data elements by clipping the selected region by zooming in. For example, the user may want to select data elements of interest (e.g., an area representing potentially suspicious network activity) of the visual representation to perform further analysis. The user may select the data elements of interest on the visual representation, and clip and zoom-in to this arbitrary area for further analysis. The selected area may be marked for clipping. In some examples, the clipping may include removal of a diagonal line from the displayed graphical representation.

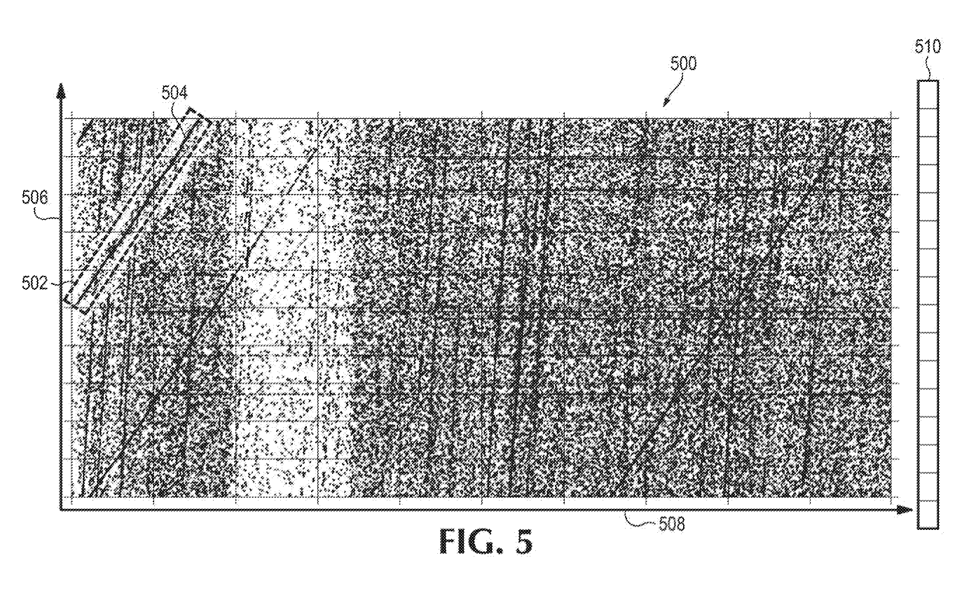

FIG. 5 illustrates an example of a selection of an arbitrarily shaped region of a visual representation of data. For example, an interesting port scan diagonal line 504 may be selected for clipping. The arbitrarily shaped region represented here by the port scan diagonal line 504 is illustrated (for illustration purposes only) to be enclosed in a rectangular area 502. Area 502 is displayed only to highlight the diagonal line 504. The horizontal axis 508 may represent time, the vertical axis 506 may represent port, and the color of a pixel may represent the numerical value of an IP address. For example, color may represent the value of an IP address. For example, a color spectrum 510 may be a color spectrum to represent a plurality of values of IP addresses.

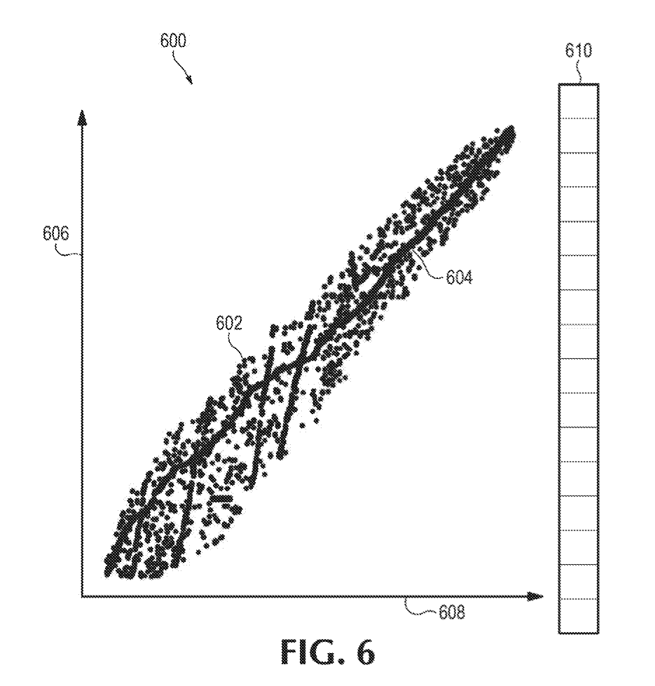

FIG. 6 illustrates an example of providing a modified visual representation of the selected region of FIG. 5. For example, the port scan diagonal line 504 (of FIG. 5) may be clipped and provided as a modified visual representation 600. The diagonal line is shown in more detail as diagonal region 604. The selected region of FIG. 5 is represented by the area 602. In some examples, the modified visual representation 600 may be a zoomed in portion of a selected region in a visual representation. The horizontal axis 608 may represent time, the vertical axis 606 may represent port, and the color of a pixel may represent the numerical value of an IP address. For example, color may represent the value of an IP address. For example, a color spectrum 610 may be a color spectrum to represent a plurality of values of IP addresses.

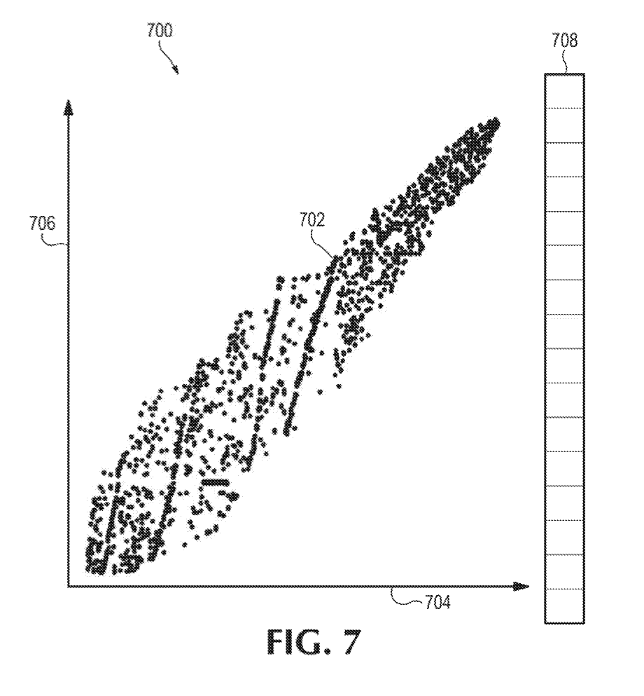

FIG. 7 illustrates an example of removal of a diagonal line from the selected region 602 of FIG. 6. Selected region 602 of FIG. 6 may be modified by removing the diagonal region 604. For example, a user may select a portion of the visual representation as the port scan diagonal line 504 in FIG. 5. The interaction processor 108 may identify this region, and provide the coordinates to the display module 104. The display module 104 may display the modified visual representation 600 of FIG. 6. The user may want to further investigate this portion of the modified visual representation 600. Accordingly, the user may select the diagonal region 604 for clipping. The interaction processor 108 may identify this region, and provide the coordinates to the display module 104. The display module 104 may display the modified visual representation 700 of FIG. 7, where the diagonal region 604 of FIG. 6 is removed. Accordingly, region 702 is the region 602 of FIG. 6 with the diagonal region 604 clipped. In some examples, the remaining pixels may be highlighted. This may allow the user to focus on the IP-Port activities that are surrounding the diagonal region 604 of FIG. 6. The horizontal axis 704 may represent time, the vertical axis 706 may represent port, and the color of a pixel may represent the numerical value of an IP address. For example, color may represent the value of an IP address. For example, a color spectrum 708 may be a color spectrum to represent a plurality of values of IP addresses.

In some examples, the interaction processor 108 may identify, identifying, in the clipped region, selection of data elements of interest to the user, and may prompt the display module to automatically blur visual representations of data elements different from the data elements of interest by modifying the pixel attributes of respective pixels. In some examples, the blurring may include modifying pixel attributes such as color, light intensity, sharpness, and so forth. In some examples, the highlighting may include blurring a pixel. For example, sharp edges and/or pixels may drag a user's attention in an overcrowded display. Accordingly, a visual analysis may suffer under visual cognitive overload since the user may not be able to focus on every data point. Generally, in existing methods, in highlighting and/or filtering, only the data elements (e.g., pixels) of interest to the user may be shown. However, this removal of all of the other data elements (other than those of Immediate interest to the user) also removes data relations that may be relevant for analysis of the data pattern.

As disclosed herein, blurring provides the means to emphasize some data elements while maintaining their context and thus, preserving respective data relations. Generally, this may be beneficial to an analysis of data patterns, in contrast to the existing standard methods of highlighting and/or filtering.

In some examples, the blurring may be based on a Gaussian kernel. A radius around a pixel in both directions may define an effect of blurring. In some examples, the radius may be defined by the user. Generally, a value of 10 may be utilized in many applications. In some examples, the user may specify a variable, threshold, and/or condition applied for blurring. For example, the user may decide to analyze one IP address, and may therefore blur all pixels that contain other IP addresses. In some examples, a pixel represented by color “Red” may be surrounded by pixels represented by blurred (e.g., lighter) shades of “Red” such as pink. In some examples, the further a pixel is from the pixel represented by color “Red”, the lighter the shade of “Red”. Likewise, a pixel represented by color “Green” may be surrounded by pixels represented by blurred (e.g., lighter) shades of “Green” such as light green. In some examples, the further a pixel is from the pixel represented by color “Green”, the lighter the shade of “Green”. Accordingly, the blurring algorithm blurs pixels of the visualization that fulfill such a condition—all pixels other than the pixels associated with the specified IP address may be blurred.

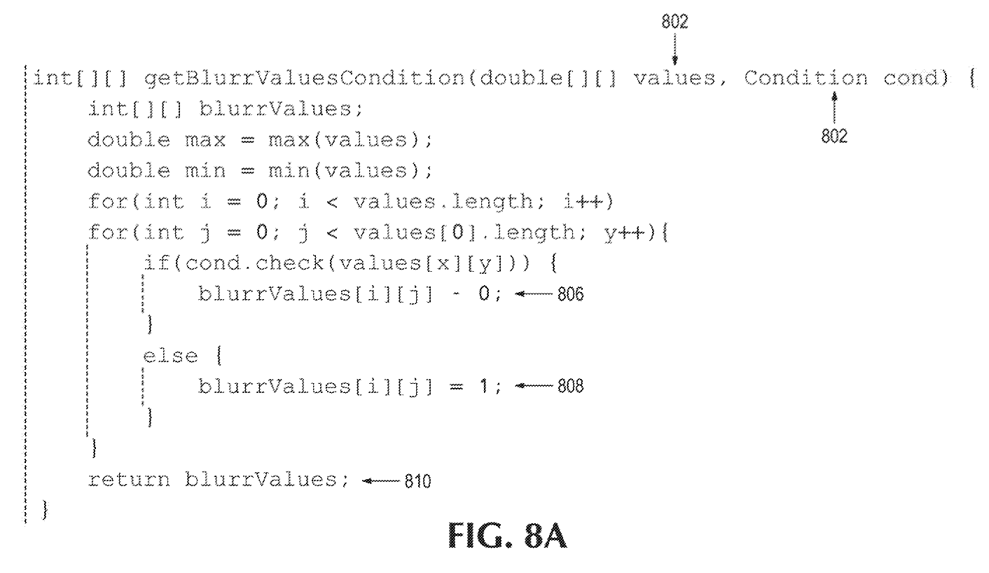

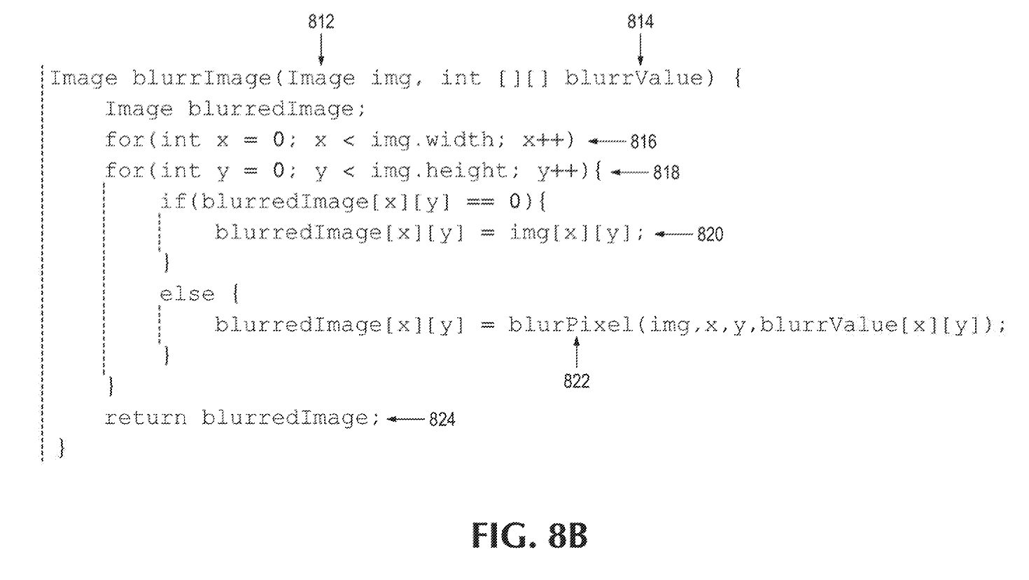

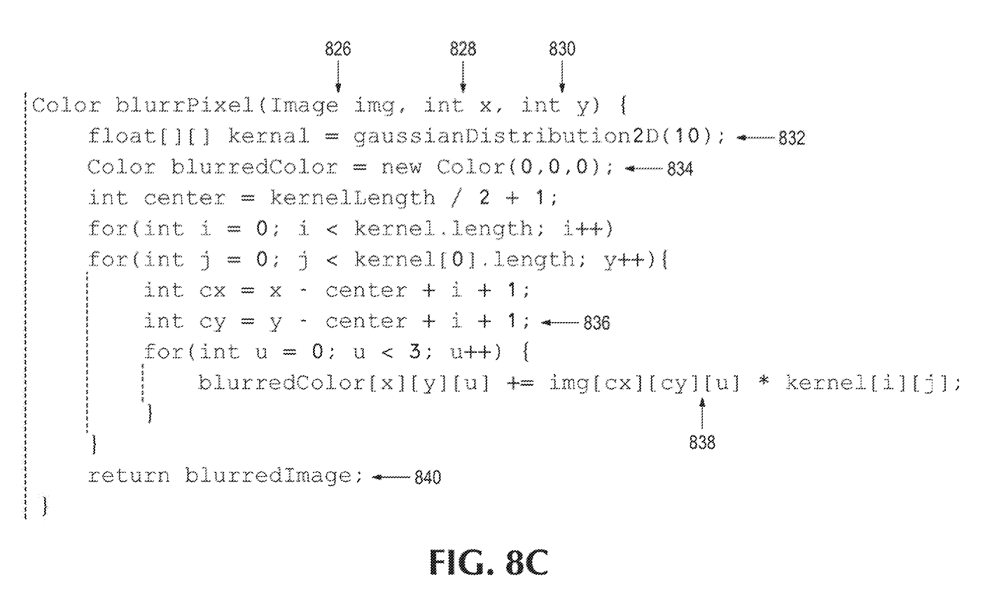

FIGS. 8A-8C illustrate example algorithms for blurring a visual representation. FIG. 8A illustrates an example algorithm that identifies data elements of interest to a user. The interaction processor 108 may receive, via the interactive graphical user interface 106, threshold values 802, and/or condition 804 applied for blurring. In some examples, the user may input the threshold values 802, and/or condition 804. In some examples, each data element may be represented by pixel attributes of a pixel, and a blurrValues 810 may be identified for each pixel. For example, at 806, each pixel may be associated with a value of 0 if the condition 804 is not satisfied, and at 808, each pixel may be associated with a value of 1 if the condition 804 is satisfied. The algorithm outputs blurrValues 810 representative of the data elements of interest to the user.

FIG. 8B illustrates an example algorithm for providing a modified visual representation of the selected region. The interaction processor 108 may receive, via the interactive graphical user interface 106, Image 812 (e.g., the visual representation that includes the selected region). The interaction processor 108 may receive, via the interactive graphical user interface 106, blurrValue 814 indicative of data elements of interest to the user. In some examples, blurrValue 814 may be blurrValue 810 described in FIG. 8A. In some examples, the user may input the Image 812 and the blurrValue 814. In some examples, the modification of the visual representation may be performed pixel-wise, where each pixel is represented by a horizontal component x and a vertical component y, indicated by img[x][y]. For example, at 816, the example algorithm may determine if the x value for the pixel is within an x-value range for the visual representation. Also, for example, at 818, the example algorithm may determine if the y value for the pixel is within a y-value range for the visual representation. At 820, if the blurrValue 814 for the pixel is 0, then the original pixel attributes, including color, are preserved for the pixel. This is indicated at 820 by “blurredImage[x][y]=img[x][y]”. At 822, if the blurrValue 814 for the pixel is 1, then the original pixel attributes, including color, may be modified. This is indicated, at 822, by “blurredImage[x][y]=blurPixel(img, x, y, blurrValue[x][y])”, where blurredImage[x][y] refers to the new pixel attribute for pixel [x][y], and blurrValue[x][y] is based on blurrValue 814. Also, for example, the routine blurPixel may be a call to a subroutine as described with reference to FIG. 8C. The algorithm outputs blurredImage 824 that blurs the pixel. When blurring is applied to each pixel in the visual representation, a modified visual representation of the selected region is generated, highlighting the data elements of interest to the user by blurring the data elements that are not of interest to the user.

FIG. 8C illustrates an example algorithm for applying a blurring color to a pixel. The interaction processor 108 may receive, via the interactive graphical user interface 106, Image 826 (e.g., the visual representation that includes the selected region). Also, for example, the interaction processor 108 may receive, via the interactive graphical user interface 106, int x 828 and int y 830. For example, int x 828 and int y 830 may be input from the call to subroutine blurrPixel as described at 822 of FIG. 8B. In some examples, as indicated at 832, a two-dimensional Gaussian distribution may be applied, with a radius of 10. At 834, a blurredColor 840 may be associated with the pixel. At 836, a pixel associated with a data point that is not of interest to the user may be blurred. At 838, pixels surrounding the data point that is not of interest to the user may be blurred based on the kernel (e.g., based on the Gaussian distribution) generated at 832. The algorithm outputs blurredColor 840 that blurs the pixel and its surrounding pixels based on the Gaussian distribution.

Accordingly, a modified visual representation including the data elements of interest to the user may be generated. For example, if a pixel is associated with a blurrValue 0 at 806 of FIG. 8A, then at 820 of FIG. 8B, the original pixel attributes, including color, are preserved for the pixel. Also, for example, if a pixel is associated with a blurrValue 1 at 808 of FIG. 8A, then at 822 of FIG. 8B, the original pixel attributes, including color, may be modified. In some examples, this modification may be performed by calling a subroutine blurrPixel as described in FIG. 8C, where neighborhoods of pixels that are not of interest to the user may be blurred based on a Gaussian distribution.

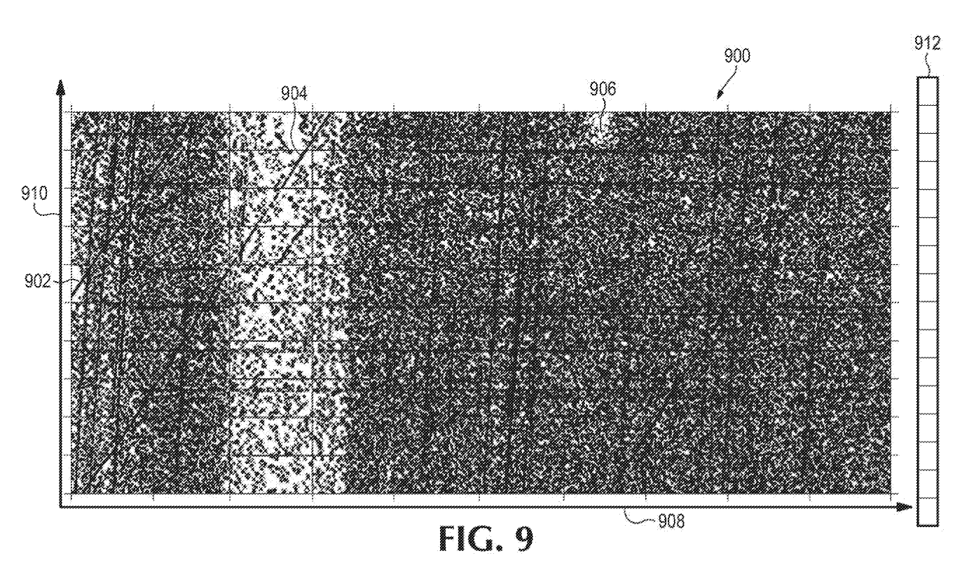

FIG. 9 illustrates an example of blurring visual representations of data elements different from the data elements of interest. A blurred port graph is illustrated that de-emphasizes data points that are not of interest (e.g., below certain user defined thresholds). FIG. 9 shows that the blurred region may be ignored. The important patterns are the diagonal lines (e.g., lines 902, 904) and surrounding pixels. Blurred region 906 is also illustrated. Users may ignore the data points corresponding to the blurred pixels from the big data graph. The horizontal axis 908 may represent time, the vertical axis 910 may represent port, and the color of a pixel may represent the numerical value of an IP address. For example, color may represent the value of an IP address. For example, a color spectrum 912 may be a color spectrum to represent a plurality of values of IP addresses.

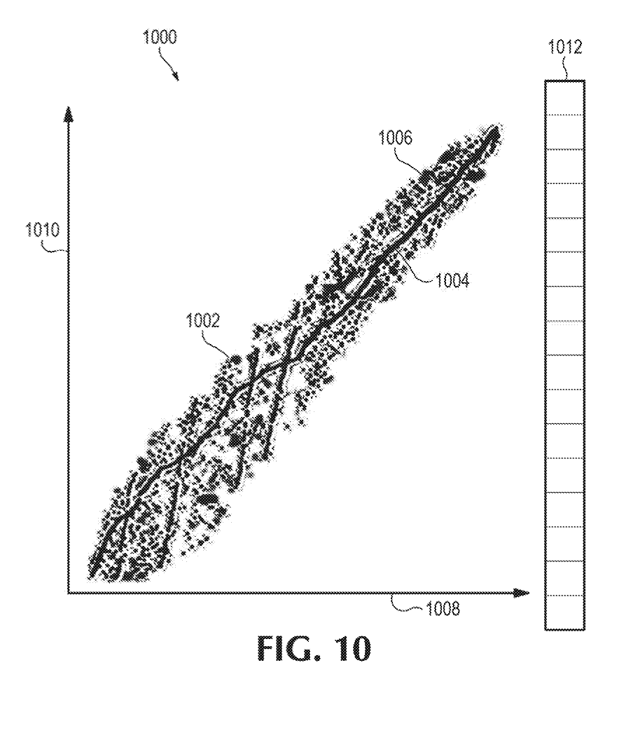

FIG. 10 illustrates another example of blurring visual representations of data elements different from the data elements of interest. As illustrated, all data elements that are not on the port scan diagonal 804 are blurred. A first blurred area 802 and a second blurred area 806 are shown. Accordingly, data elements along the port scan diagonal 804 are highlighted for analysis by a user. The horizontal axis 1008 may represent time, the vertical axis 1010 may represent port, and the color of a pixel may represent the numerical value of an IP address. For example, color may represent the value of an IP address. For example, a color spectrum 1012 may be a color spectrum to represent a plurality of values of IP addresses.

The components of system 100 may be computing resources, each including a suitable combination of a physical computing device, a virtual computing device, a network, software, a cloud infrastructure, a hybrid cloud infrastructure that includes a first cloud infrastructure and a second cloud infrastructure that is different from the first cloud infrastructure, and so forth. The components of system 100 may be a combination of hardware and programming for performing a designated function. In some instances, each component may include a processor and a memory, while programming code is stored on that memory and executable by a processor to perform a designated function.

For example, the plurality of data elements 102 may be stored in a plurality of databases communicatively linked over a network. System 100 may include hardware to physically store the plurality of data elements 102, and processors to physically process the plurality of data elements 102. System 100 may also include software algorithms to access the plurality of data elements 102 and share them over a network.

As another example, display module 104 may include software programming to receive the plurality of data elements 102 over a physical network. Display module 104 may also include software programming to automatically generate a visual representation of the plurality of data elements 102. For example, display module 104 may include software programming to represent a given data element by a pixel, and determine and associate pixel attributes based on the characteristics of the given data element. Display module 104 may also include software programming to dynamically interact with the interaction processor 108 to receive feedback related to selection of an arbitrarily shaped region of the visual representation, and selection of data elements of interest to the user, and modify the visual representation accordingly. Display module 104 may include hardware, including physical processors and memory to house and process such software algorithms. Display module 104 may also include physical networks to be communicatively linked to the interaction processor 108 and the interactive graphical user interface 106.

Also, for example, the interactive graphical user interface 106 may include software programming to receive and implement the visual representation for display from the display module 104. Interactive graphical user interface 106 may also include software programming to interactively and iteratively interact with the user. The interactive graphical user interface 106 may include hardware, including physical processors and memory to display the interactive visual representation of the plurality of data elements 102. Also, for example, the interactive graphical user interface 106 may include a computing device to provide the graphical user interface. Interactive graphical user interface 106 may also include software programming to dynamically interact with the interaction processor 108 to provide feedback related to selection of an arbitrarily shaped region of the visual representation, and selection of data elements of interest to the user. Evaluator 108 may also include hardware, including physical processors and memory to house and process such software algorithms, and physical networks to be communicatively linked to the display module 104 and the interaction processor 108.

Likewise, the interaction processor 108 may include software programming to receive feedback from the interactive graphical user interface 106. The interaction processor 114 may also include software programming to provide the feedback to the display module 104 to modify the visual representation. The interaction processor 114 may also include hardware, including physical processors and memory to house and process such software algorithms, and physical networks to be communicatively linked to the display module 104, the interactive graphical user interface 106, and to computing devices.

The computing device may be, for example, a web-based server, a local area network server, a cloud-based server, a notebook computer, a desktop computer, an all-in-one system, a tablet computing device, a mobile phone, an electronic book reader, or any other electronic device suitable for provisioning a computing resource to perform an interactive selection of data features based on a dimension interestingness measure. Computing device may include a processor and a computer-readable storage medium.

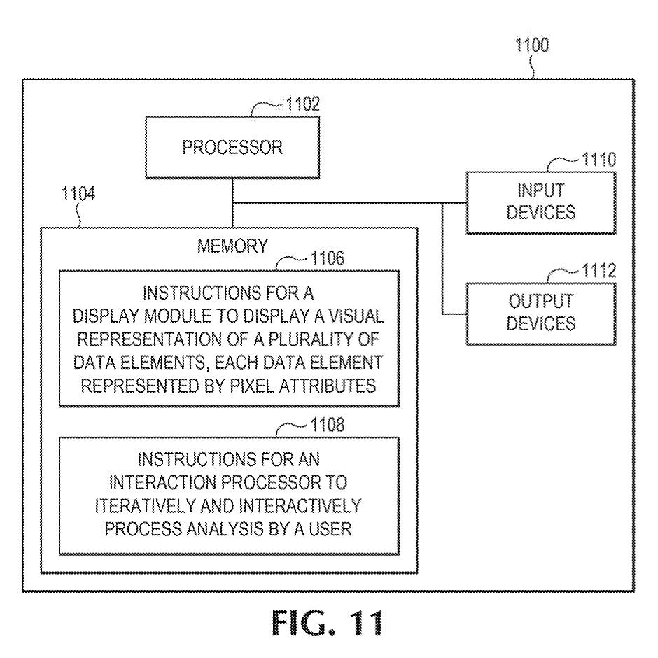

FIG. 11 is a block diagram illustrating one example of a processing system 1100 for implementing the system 100 for visually interactive and iterative analysis of data patterns by a user. Processing system 1100 includes a processor 1102, a memory 1104, input devices 1110, and output devices 1112. A plurality of data elements may be accessed from an external database (not shown in the figure) that may be interactively linked to the processing system 1100 via the processor 1102. In some examples, the plurality of data elements may be stored in the memory 1104. Processor 1102, memory 1104, input devices 1110, and output devices 1112 are coupled to each other through communication link (e.g., a bus).

Processor 1102 includes a Central Processing Unit (CPU) or another suitable processor. In some examples, memory 1104 stores machine readable instructions executed by processor 1102 for operating processing system 1100. Memory 1104 includes any suitable combination of volatile and/or non-volatile memory, such as combinations of Random Access Memory (RAM), Read-Only Memory (ROM), flash memory, and/or other suitable memory.

Memory 1104 stores instructions to be executed by processor 1102 including instructions of a display module 1106, and instructions of an interaction processor 1108. In some examples, instructions of display module 1106, and instructions of an interaction processor 1108, include instructions of display module 104, and instructions of interaction processor 108, respectively, as previously described and illustrated with reference to FIG. 1.

Processor 1102 executes instructions of display module 1106 to display, via an interactive graphical user interface, a visual representation of a plurality of data elements and respective data relations between the data elements, and wherein each data element is represented by pixel attributes of a pixel. In some examples, processor 1102 also executes instructions of display module 1104 to represent each data element with a pixel.

Processor 1102 executes instructions of an interaction processor 1108 to iteratively and interactively process analysis by a user by identifying selection, by the user, of an arbitrarily shaped region of the visual representation, clipping the selected region by zooming in to the selected region, identifying, in the clipped region, selection of data elements of interest to the user, and prompting the display module to automatically blur visual representations of data elements different from the data elements of interest by modifying the pixel attributes of respective pixels.

In some examples, processor 1102 executes instructions of an interaction processor 1106 to provide the modified visual representation of the sub-plurality of data elements by clipping the selected region. In some examples, processor 1102 executes instructions of an interaction processor 1106 to clip the visual representation by removal of a diagonal line from the displayed graphical representation.

Input devices 1110 include a keyboard, mouse, data ports, and/or other suitable devices for inputting information into processing system 1100. In some examples, input devices 1110, such as a computing device, are used by the interaction processor 1108 to interact with a user. Output devices 1112 include a monitor, speakers, data ports, and/or other suitable devices for outputting information from processing system 1100. In some examples, output devices 1112 are used to provide an interactive visual representation of the plurality of data elements.

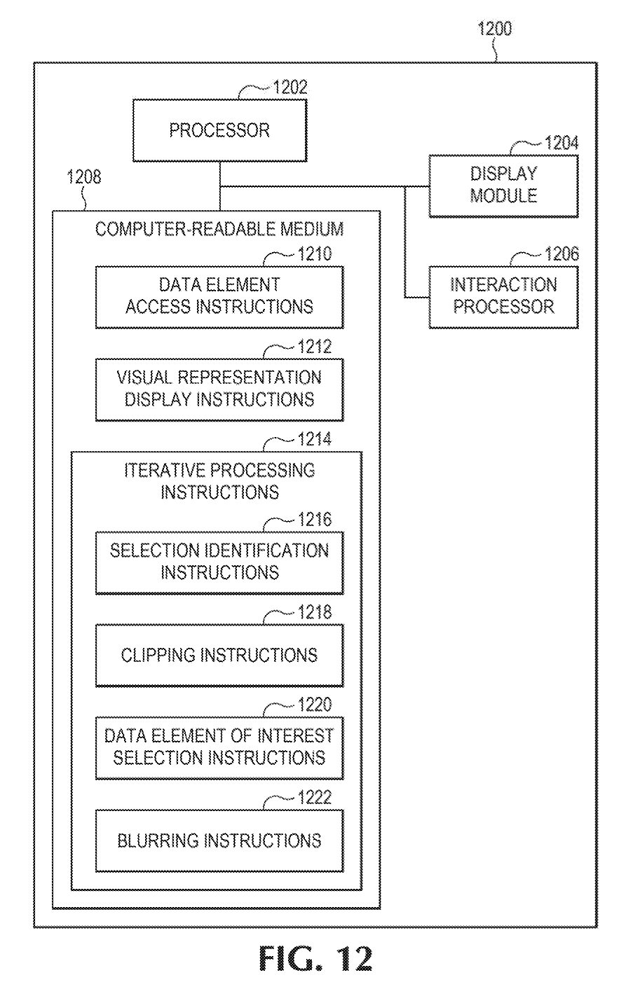

FIG. 12 is a block diagram illustrating one example of a computer readable medium for visually interactive and iterative analysis of data patterns by a user. Processing system 1200 includes a processor 1202, a computer readable medium 1208, a display module 1204, and an interaction processor 1206. Processor 1202, computer readable medium 1208, display module 1204, and interaction processor 1206 are coupled to each other through communication link (e.g., a bus).

Processor 1202 executes instructions included in the computer readable medium 1208. Computer readable medium 1208 includes data element access instructions 1210 of a display module 1204 to access a plurality of data elements from a database. Computer readable medium 1208 includes visual representation display instructions 1212 of a display module 1204 to display, via an interactive graphical user interface, a visual representation of a plurality of data elements and respective data relations between the data elements, and wherein each data element is represented by pixel attributes of a pixel.

Computer readable medium 1208 includes iterative processing instructions 1214 of an interaction processor 1206 to iteratively and interactively process visual analysis by a user, the iterative processing instructions 1214 including selection identification instructions 1216 to identify selection, by the user, of an arbitrarily shaped region of the visual representation, clipping instructions 1218 to clip the selected region by zooming in to the selected region, data element of interest selection instructions 1220 to identify, in the clipped region, selection of data elements of interest to the user, and blurring instructions 1222 to automatically blur visual representations of data elements different from the data elements of interest by modifying the pixel attributes of respective pixels.

As used herein, a “computer readable medium” may be any electronic, magnetic, optical, or other physical storage apparatus to contain or store information such as executable instructions, data, and the like. For example, any computer readable storage medium described herein may be any of Random Access Memory (RAM), volatile memory, non-volatile memory, flash memory, a storage drive (e.g., a hard drive), a solid state drive, and the like, or a combination thereof. For example, the computer readable medium 1208 can include one of or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

As described herein, various components of the processing system 400 are identified and refer to a combination of hardware and programming configured to perform a designated function. As illustrated in FIG. 12, the programming may be processor executable instructions stored on tangible computer readable medium 1208, and the hardware may include processor 1202 for executing those instructions. Thus, computer readable medium 1208 may store program instructions that, when executed by processor 1202, implement the various components of the processing system 1200.

Such computer readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

Computer readable medium 1208 may be any of a number of memory components capable of storing instructions that can be executed by processor 1202. Computer readable medium 1208 may be non-transitory in the sense that it does not encompass a transitory signal but instead is made up of one or more memory components configured to store the relevant instructions. Computer readable medium 1208 may be implemented in a single device or distributed across devices. Likewise, processor 1202 represents any number of processors capable of executing instructions stored by computer readable medium 1208. Processor 1202 may be integrated in a single device or distributed across devices. Further, computer readable medium 1208 may be fully or partially integrated in the same device as processor 1202 (as illustrated), or it may be separate but accessible to that device and processor 1202. In some examples, computer readable medium 1208 may be a machine-readable storage medium.

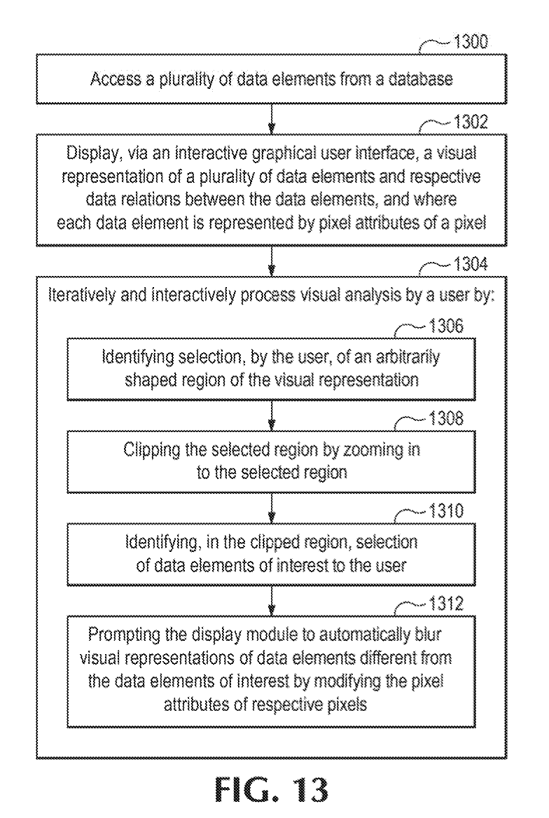

FIG. 13 is a flow diagram illustrating one example of a method for visually interactive and iterative analysis of data patterns by a user. At 1300, a plurality of data elements may be accessed from a database. At 1302, a visual representation of the plurality of data elements and respective data relations between data elements may be displayed via a graphical user interface, where each data element is represented by pixel attributes of a pixel. At 1304, visual analysis by a user may be iteratively and interactively processed. Such iterative and interactive processing may include, at 1306, identifying selection, by the user, of an arbitrarily shaped region of the visual representation. At 1308, clipping the selected region by zooming in to the selected region. At 1310, identifying, in the clipped region, selection of data elements of interest to the user, and at 1312 prompting the display module to automatically blur visual representations of data elements different from the data elements of interest by modifying the pixel attributes of respective pixels.

In some examples, clipping may include removal of a diagonal line from the displayed graphical representation.

In some examples, the blurring may be based on a Gaussian kernel.

In some examples, modifying the pixel attributes is based on a threshold provided by the user.

In some examples, a given data element of the plurality of data elements is a pair comprising an IP address and a port number at a time interval, and the interaction processor further identifies the selection of the region based on a selection of an IP address.

In some examples, the pixel attribute associated with the pixel represents a characteristic of the data element represented by the pixel.

Examples of the disclosure provide a generalized system for visually interactive and iterative analysis of data patterns by a user. The generalized system provides a combination of visual analytics methods with human interactions to dynamically explore security threats in big data. Users may be able to refine their hypotheses through interaction and re-process these two phases of visual analytics techniques. These two phases of process may be built at a record level. Each data point (e.g., a pair of IP address and port number at a certain time period) may be represented by a smallest element, such as a pixel. Each pixel may be accessible by users.

Although specific examples have been illustrated and described herein, especially as related to healthcare data, the examples illustrate applications to any structured data. Accordingly, there may be a variety of alternate and/or equivalent implementations that may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a display module to display, via an interactive graphical user interface, a visual representation of a plurality of data elements and respective data relations between the data elements, wherein each data element is represented by pixel attributes of a pixel;
an interaction processor to iteratively and interactively process analysis by a user based on:
identifying selection, by the user, of an arbitrarily shaped region of the visual representation,
clipping the selected region by zooming in to the selected region,
identifying, in the clipped region, selection of data elements of interest to the user, and
prompting the display module to automatically blur visual representations of data elements different from the data elements of interest by modifying the pixel attributes of respective pixels.

2. The system of claim 1, wherein the clipping includes removal of a diagonal line from the displayed graphical representation.

3. The system of claim 1, wherein the blurring is based on a Gaussian kernel.

4. The system of claim 1, wherein modifying the pixel attributes is based on a threshold provided by the user.

5. The system of claim 1, wherein a given data element of the plurality of data elements is a pair comprising an IP address and a port number at a time interval, and the interaction processor further identifies the selection of the region based on a selection of an IP address.

6. The system of claim 1, wherein the pixel attribute associated with the pixel represents a characteristic of the data element represented by the pixel.

7. A method to iteratively and interactively process a data pattern of interest to a user, the method comprising:
accessing a plurality of data elements from a database;
displaying, via an interactive graphical user interface, a visual representation of a plurality of data elements and respective data relations between the data elements, and wherein each data element is represented by pixel attributes of a pixel; and
iteratively and interactively processing visual analysis by a user based on:
identifying selection, by the user, of an arbitrarily shaped region of the visual representation,
clipping the selected region by zooming in to the selected region,
identifying, in the clipped region, selection of data elements of interest to the user, and
prompting the display module to automatically blur visual representations of data elements different from the data elements of interest by modifying the pixel attributes of respective pixels.

8. The method of claim 7, wherein the clipping includes removal of a diagonal line from the displayed graphical representation.

9. The method of claim 7, wherein the blurring is based on a Gaussian kernel.

10. The method of claim 7, wherein modifying the pixel attributes is based on a threshold provided by the user.

11. The method of claim 7, wherein a given data element of the plurality of data elements is a pair comprising an IP address and a port number at a time interval, and the interaction processor further identifies the selection of the region based on a selection of an IP address.

12. The method of claim 7, wherein the pixel attribute associated with the pixel represents a characteristic of the data element represented by the pixel.

13. A non-transitory computer readable medium comprising executable instructions to:
access a plurality of data elements from a database;
display, via an interactive graphical user interface, a visual representation of a plurality of data elements and respective data relations between the data elements, and wherein each data element is represented by pixel attributes of a pixel; and
iteratively and interactively process visual analysis by a user, the instructions to iteratively and interactively process including instructions to:
identify selection, by the user, of an arbitrarily shaped region of the visual representation,
clip the selected region by zooming in to the selected region,
identify, in the clipped region, selection of data elements of interest to the user, and
automatically blur visual representations of data elements different from the data elements of interest by modifying the pixel attributes of respective pixels.

14. The computer readable medium of claim 13, wherein the instructions to clip include further instructions to remove a diagonal line from the displayed graphical representation.

15. The computer readable medium of claim 13, wherein the pixel attribute associated with the pixel represents a characteristic of the data element represented by the pixel.
